(19) United States
(12) Patent Application Publication
(10) Pub. No.: US 2011/0081819 A1
(43) Pub. Date: Apr. 7, 2011

(54) METHOD FOR PRODUCING ELECTRON-EMITTING DEVICE

(75) Inventors: Akiko Kitao, Atsugi-shi (JP); Yoji Teramoto, Ebina-shi (JP)

(73) Assignee: CANON KABUSHIKI KAISHA, Tokyo (JP)

(21) Appl. No.: 12/896,766

(22) Filed: Oct. 1, 2010

(30) Foreign Application Priority Data
Oct. 7, 2009 (JP) PCT/JP2009/067498

(51) Int. Cl. H01J 9/12

(52) U.S. Cl. 445/51

(57) ABSTRACT

As many protrusions as possible that contribute to electron emission are formed in a controlled manner and the protrusions are easily formed over a large area in a controlled manner. A conductive film composed of a conductive material constituting a cathode is formed by sputtering at a total pressure of 1.0 Pa or more and 2.8 Pa or less, and etching treatment is performed on the conductive film to form the cathode having a plurality of protrusions on the surface thereof.

### BACKGROUND OF THE INVENTION

1. Field of the Invention

The present invention relates to an electron-emitting device used for a display or the like.

2. Description of the Related Art

A field-emission electron-emitting device is known as an electron-emitting device used for a display or the like. PTL 1 discloses a field-emission electron-emitting device that includes fine protrusions on which an electric field is concentrated. PTL 2 discloses an electron-emitting device in which projections and depressions are formed on the surface of a conductive film. PTL 3 discloses an electron-emitting device that includes an insulating layer between a pair of conductive films, depressions being formed in the surface of the insulating layer.

### CITATION LIST

### Patent Literature

PTL 1 Japanese Patent Laid-Open No. 2002-093305
PTL 2 Japanese Patent Laid-Open No. 2006-185820
PTL 3 Japanese Patent Laid-Open No. 2001-167693

To form as many electron emission sites as possible in a controlled manner in order to improve electron emission characteristics, it is important to form protrusions in a controlled manner. However, in some cases, it was conventionally insufficient to form as many protrusions as possible that contribute to electron emission in a controlled manner or to easily form the protrusions over a large area in a controlled manner. Accordingly, an aspect of the present invention is to provide a method for easily producing fine protrusions with high controllability to achieve satisfactory electron emission characteristics.

### SUMMARY OF THE INVENTION

According to an aspect of the present invention, a method for producing an electron-emitting device including a cathode having a plurality of protrusions is provided, the method at least including a step of forming a conductive film composed of a material constituting the cathode on a base by sputtering at a total pressure of 1.0 Pa or more and 2.8 Pa or less; and a step of performing etching treatment on the conductive film to form a cathode having a plurality of protrusions on a surface thereof.

Further aspects of the present invention will become apparent from the following description of exemplary embodiments with reference to the attached drawings.

### BRIEF DESCRIPTION OF THE DRAWINGS

FIGS. 1A to 1C are schematic views of an electron-emitting device produced by a production method according to an embodiment.

FIGS. 2A to 2C show modifications of the electron-emitting device produced by the production method according to the embodiment.

FIG. 3 is an enlarged schematic view of a portion of the electron-emitting device.

FIGS. 4A and 4B are enlarged schematic views of a portion of the electron-emitting device.

FIG. 5A is a diagram showing the relationship between film formation pressure and standard deviation of distance d and FIG. 5B is a diagram showing the relationship between standard deviation of distance d and electron emission current Ie.

FIG. 6A is a diagram showing the relationship between film formation pressure and film density and FIG. 6B is a diagram showing the relationship between etching time and standard deviation of distance d.

FIG. 7 is a diagram showing an image of etching.

FIGS. 8A to 8F are schematic views showing the production method of the electron-emitting device according to the embodiment.

FIG. 9 is a diagram that describes a configuration for measuring electron emission characteristics.

FIGS. 10A and 10B are schematic views of image display apparatuses.

### DESCRIPTION OF THE EMBODIMENTS

Various exemplary embodiments of the present invention will now be described in detail with reference to the attached drawings. The sizes, materials, shapes, relative configurations, and the like of constituent elements described in this embodiment are not intended to limit the scope of the present invention unless otherwise specified.

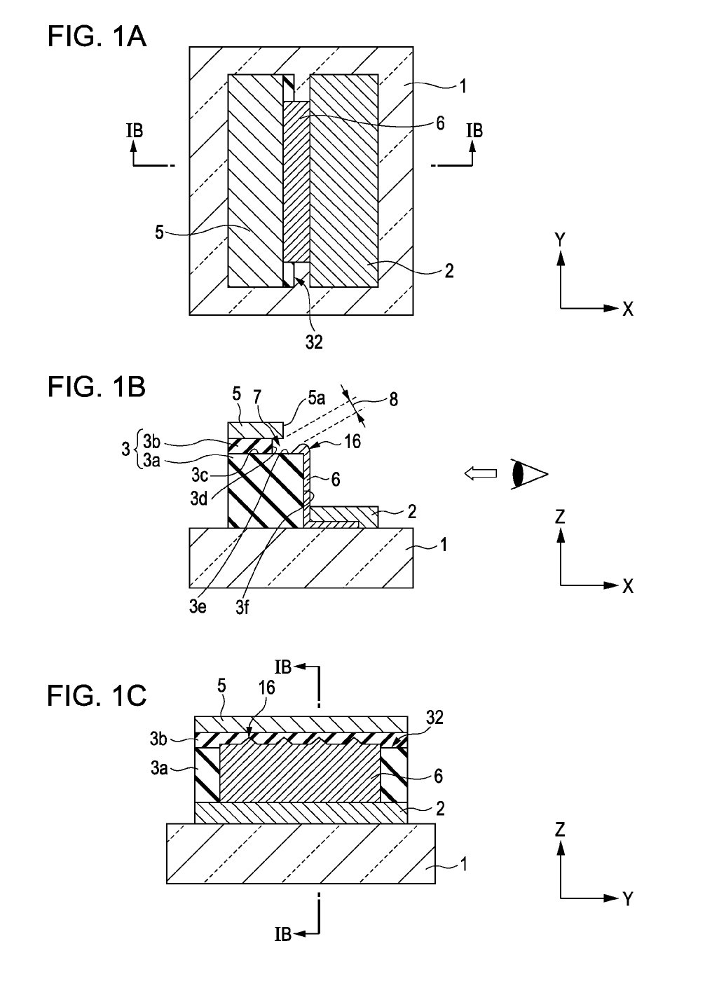

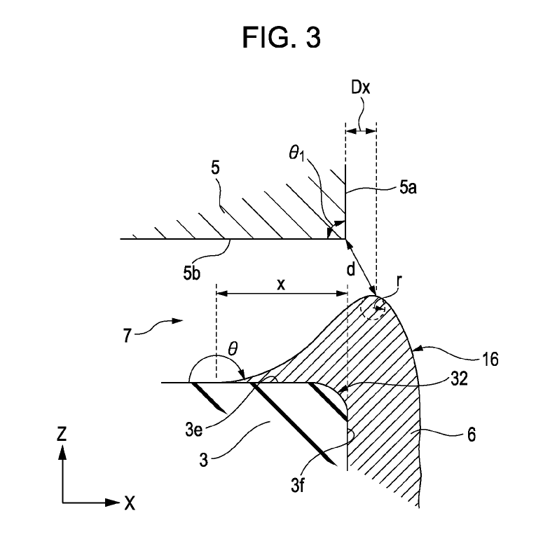

An example of an electron-emitting device to which the production method according to the present invention is suitably applied will be described with reference to FIGS. 1A to 1C and FIG. 3.

FIG. 1A is a schematic plan view of an electron-emitting device, and FIG. 1B is a schematic sectional view taken along line IB-IB of FIG. 1A and line IB-IB of FIG. 1C. FIG. 1C is a side view when the electron-emitting device is viewed in a direction indicated by an arrow of FIG. 1B. FIG. 3 is an enlarged schematic view of a portion in FIG. 1B.

The electron-emitting device includes an insulating member 3 stacked on the surface of a substrate 1 and a gate 5 disposed on the upper face of the insulating member 3 so that the insulating member 3 is sandwiched between the substrate 1 and the gate 5. The electron-emitting device further includes a cathode 6 disposed on the side face of the insulating member 3. The cathode 6 partially extends to part of the upper face of the insulating member 3 and includes a plurality of protrusions 16. The plurality of protrusions 16 are arranged along a corner 32 that is a boundary portion between the side face (3f in FIG. 1B) and the upper face (3e in FIG. 1B) of the insulating member 3. The plurality of protrusions 16 each correspond to an electron emission portion. A gap 8 that is a space is formed between the gate 5 and the protrusions 16 of the cathode 6. By applying a voltage between the cathode 6 and the gate 5 such that the potential of the gate 5 is higher than that of the cathode 6, electrons are subjected to field emission from the plurality of protrusions 16 of the cathode 6. The arrangement position of the gate 5 is not limited to the configuration shown in FIGS. 1A to 1C. In other words, the gate 5 may be arranged apart from the cathode 6 at a certain distance so that an electric field that makes it possible to cause field emission can be applied to the plurality of protrusions 16, which are electron emission portions. In this example, a configuration in which the insulating member 3 is constituted by a stacked body of a first insulating layer 3a and a second insulating layer 3b is described, but the insulating member 3 may be constituted by a single insulating layer. Alternatively, the insulating member 3 may be constituted by three or more insulating layers. In the configuration shown in FIGS. 1A to 1C, the second insulating layer 3b is stacked on part of an upper face 3e of the first insulating layer 3a. That is, the second insulating layer 3b is disposed so that a side face 3d of the second insulating layer 3b is more apart from the cathode 6 than a side face 3f of the first insulating layer 3a. In such a configuration, a depression 7 is formed in the upper face of the insulating member 3. Thus, the upper face of the insulating member 3 has a step.

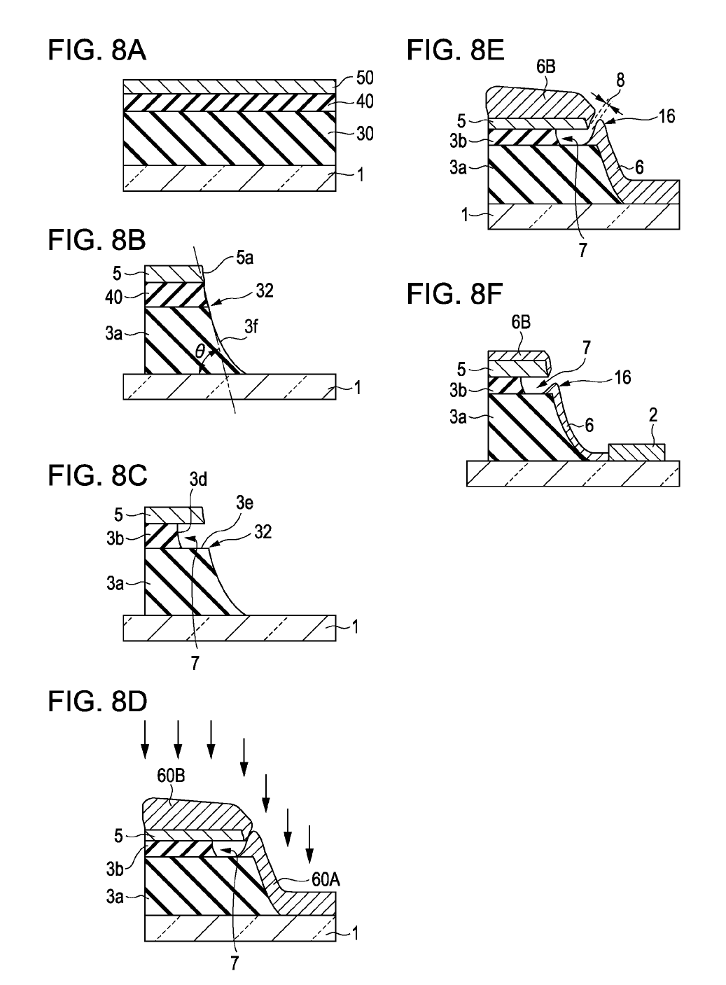

The steps of the production method of this embodiment will now be briefly described with reference to FIGS. 8A to 8F by taking the above-described electron-emitting device as an example. Subsequently, each of the steps will be described in detail.

Step 1

An insulating layer 30 to be a first insulating layer 3a is formed on the surface of the substrate 1. An insulating layer 40 to be a second insulating layer 3b is then stacked on the upper face of the insulating layer 30. A conductive layer 50 to be a gate 5 is stacked on the upper face of the insulating layer 40 (FIG. 8A).

The insulating layer 40 is composed of a material different from that of the insulating layer 30 so that the amount of the insulating layer 40 etched with an etching solution (etchant) used in the step 3 described below is larger than that of the insulating layer 30 etched.

Step 2

Next, etching treatment (first etching treatment) is performed on the conductive layer 50, the insulating layer 40, and the insulating layer 30 (FIG. 8B).

In the first etching treatment, specifically, a resist pattern is formed on the conductive layer 50 by photolithography or the like, and the conductive layer 50, the insulating layer 40, and the insulating layer 30 are then etched. Through the step 2, a first insulating layer 3a and a gate 5 that constitute the electron-emitting device shown in FIGS. 1A to 1C are basically formed. As shown in FIG. 8B, the angle (θ) between the side face (oblique face) 3f of the first insulating layer 3a formed in this step and the surface of the substrate 1 is preferably smaller than 90°. Furthermore, the angle between the side face (oblique face) 5a of the gate 5 and the upper face 3e of the first insulating layer 3a (or the surface of the substrate 1) is preferably smaller than the angle (θ) between the side face (oblique face) 3f of the first insulating layer 3a and the surface of the substrate 1.

Step 3

Subsequently, etching treatment (second etching treatment) is performed on the insulating layer 40 (FIG. 8C).

Through the step 3, a second insulating layer 3b that constitutes the electron-emitting device shown in FIGS. 1A to 1C is basically formed. Consequently, there is formed a depression 7 defined by part of the upper face 3e of the first insulating layer 3a and the side face 3d of the second insulating layer 3b. Specifically, the depression 7 is defined by part of the lower face of the gate 5, part of the upper face 3e of the first insulating layer 3a, and the side face 3d of the second insulating layer 3b. In the step 3, since the side face of the insulating layer 40 is etched, part of the upper face 3e of the first insulating layer 3a is exposed. A corner 32 is a portion where the upper face 3e of the first insulating layer 3a and the side face 3f of the first insulating layer 3a are connected to each other (the boundary portion between the upper face 3e and the side face 3f). Through this step, a base on which a conductive film 60A described below is to be deposited is formed. That is, in this embodiment, the insulating member 3 or the insulating member 3 and the substrate 1 correspond to the base on which a conductive film 60A is to be deposited.

Step 4

The conductive film 60A composed of a conductive material that constitutes a cathode 6 is deposited by sputtering so as to extend at least from the oblique face 3f, which is the side face of the first insulating layer 3a on a cathode electrode 2 side, to part of the upper face 3e of the first insulating layer 3a (FIG. 8D).

Herein, although described below in detail, the conductive film 60A is formed by sputtering at a total pressure of 1.0 Pa or more and 2.8 Pa or less. By performing the film formation under such a condition, the conductive film 60A that includes grain portions and grain boundary portions and is suitable for forming effective protrusions 16 by etching performed in the step 5 described below can be formed.

The conductive film 60A is formed so as to cover at least part of the corner 32 of the first insulating layer 3a and extend from the side face 3f of the first insulating layer 3a to the upper face 3e of the first insulating layer 3a. At the same time, a conductive film 60B composed of a material that constitutes the cathode 6 is also deposited on the gate 5. In FIG. 8D, an example in which the conductive film 60A and the conductive film 60B are formed so as to be in contact with each other is described, but the conductive film 60A and the conductive film 60B may be formed so as not to be in contact with each other.

Step 5

Subsequently, etching treatment (third etching treatment) is performed on at least the conductive film 60A to form the cathode 6 (FIG. 8E).

The main purpose of the third etching treatment is to form a plurality of protrusions 16. In the case where the conductive film 60A and the conductive film 60B are formed so as to be in contact with each other in the step 4, a gap 8 is formed therebetween in this step. In the case where the conductive film 60A and the conductive film 60B are formed so as not to be in contact with each other in the step 4, the distance d between the gate 5 and the cathode 6 in the gap 8 is increased in this step.

Through the step 5, as shown in FIG. 1C, a plurality of protrusions 16 are formed along the corner 32 of the first insulating layer 3a. An excessive conductive material that adheres to the depression 7 can be removed through the step 5. As a result, the cathode 6 and a conductive film 6B are formed. In the step 5, all the exposed surfaces of the conductive films (60A and 60B) are exposed to an etchant. The conductive film 6B may be completely removed. If the conductive film 6B is removed, for example, a sacrificial layer is formed on the surface of the gate 5 before the step 4 and the conductive film 6B can be removed together with the sacrificial layer.

Step 6

A cathode electrode 2 for supplying electrons to the cathode 6 is formed (FIG. 8F). This step can be performed before or after the different step. The cathode 6 can also function as the cathode electrode 2 without forming the cathode electrode 2. In this case, the step 6 can be omitted.

Basically, the electron-emitting device that includes the cathode 6 having the plurality of protrusions 16 and is shown in FIGS. 1A to 1C can be formed through the (step 1) to (step 6) described above.

In the case where the conductive film 60B deposited on the gate 5 in the step 4 is left on the gate 5 as the conductive film 6B without completely removing the conductive film 60B, the conductive film 6B left can be regarded as part of the gate 5.

In the case where a step of increasing the resistance of the cathode 6 is performed after the step 5, for example, the resistance of the cathode 6 can be increased by oxidizing the cathode 6 after the step 5.

Each of the steps will now be described in detail.

Regarding Step 1

The substrate 1 is a substrate used for supporting the electron-emitting device. The substrate 1 can be composed of quartz glass, glass obtained by reducing the content of impurities such as Na, soda-lime glass, or the like. The substrate 1 needs to have not only high mechanical strength, but also the resistance to dry etching, wet etching, and an alkali or an acid such as a developer. When the electron-emitting device is used for an image display apparatus, the difference in coefficient of thermal expansion between the substrate 1 and the components stacked thereon is desirably as small as possible because a heating step or the like is performed. In consideration of heat treatment, the substrate 1 is desirably composed of a material whose alkali element does not easily diffuse into the electron-emitting device from the inside of the glass.

The insulating layer 30 (first insulating layer 3a) and the insulating layer 40 (second insulating layer 3b) are each composed of a material that is excellent in terms of workability, such as silicon nitride (typically Si₃N₄) or silicon oxide (typically SiO₂). The insulating layer 30 and the insulating layer 40 can be formed by CVD, vacuum deposition, or a typical vacuum film formation method such as sputtering. The thickness of the insulating layer 30 is set to several nanometers to several tens of micrometers and preferably several tens of nanometers to several hundreds nanometers. The thickness of the insulating layer 40 is smaller than that of the insulating layer 30 and is set to several nanometers to several hundreds nanometers and preferably several nanometers to several tens of nanometers.

In the case where the insulating layer 30 and the insulating layer 40 are stacked on the substrate 1 and then the depression 7 is formed in the step 3, the amount of the insulating layer 40 etched needs to be larger than the amount of the insulating layer 30 etched in the second etching treatment. The ratio of the etching amount of the insulating layer 40 to the etching amount of the insulating layer 30 is preferably 10 or more and more preferably 50 or more.

To achieve such a ratio of etching amounts, for example, the insulating layer 30 can be formed of a silicon nitride film and the insulating layer 40 can be formed of a silicon oxide film, a PSG film having a high concentration of phosphorus, or a BSG film having a high concentration of boron. Herein, PSG is phosphosilicate glass and BSG is boron-silicate glass.

The conductive layer 50 (gate 5) has conductivity and is formed by vapor deposition or a typical vacuum film formation method such as sputtering. The conductive layer 50 to be the gate 5 is suitably composed of a material having conductivity, high thermal conductivity, and a high melting point. Examples of the material include metals such as Be, Mg, Ti, Zr, Hf, V, Nb, Ta, Mo, W, Al, Cu, Ni, Cr, Au, Pt, and Pd and alloys thereof. Furthermore, carbides, borides, and nitrides can be used. The thickness of the conductive layer 50 (gate 5) is set to several nanometers to several hundreds nanometers and preferably several tens of nanometers to several hundreds nanometers. Since the conductive layer 50 to be the gate 5 sometimes has a thickness smaller than that of the cathode electrode 2, the conductive layer 50 is desirably composed of a material with lower resistance than the material of the cathode electrode 2.

Regarding Step 2

In the first etching treatment, RIE (reactive ion etching) is preferably used. Through RIE, a material can be precisely etched by applying an etching gas in the plasma state to the material.

In the case where the component to be processed is composed of a material that forms a fluoride, a fluorine gas such as CF₄, CHF₃, or SF₆ is selected as gas used for RIE. In the case where the component to be processed is composed of a material such as Si or Al that forms a chloride, a chlorine gas such as Cl₂ or BCl₃ is selected. Furthermore, at least one of hydrogen gas, oxygen gas, and argon gas is preferably added to the etching gas to ensure the selection ratio of the material to a resist and to ensure the smoothness of the etched surface or increase the etching rate.

Through the step 2, the first insulating layer 3a and the gate 5 each having the same shape or substantially the same shape as that shown in FIGS. 1A to 1C are basically formed. However, this does not mean that the first insulating layer 3a and the gate 5 are not etched at all in the etching treatments performed after the step 2.

The angle (indicated by θ in FIG. 8B) between the side face (oblique face) 3f of the first insulating layer 3a and the surface of the substrate 1 can be controlled to a desired value by controlling the conditions such as the type of gas and pressure. The angle θ is preferably smaller than 90°. By setting θ to smaller than 90°, the side face 5a of the gate 5 on the cathode electrode 2 side can be made to be further recessed than the side face 3f of the first insulating layer 3a on the cathode electrode 2 side is. Moreover, the angle between the side face (oblique face) 5a of the gate 5 and the upper face 3e of the first insulating layer 3a (or the surface of the substrate 1) is preferably smaller than the angle between the side face (oblique face) 3f of the first insulating layer 3a and the surface of the substrate 1. Herein, the angle between the upper face 3e of the first insulating layer 3a and the side face 3f of the first insulating layer 3a is regarded as 180°−θ. When a tangent to the side face 3f of the first insulating layer 3a at the corner 32 is drawn in the direction toward the substrate 1, the angle θ can be represented by an angle between the substrate 1 and the tangent (refer to FIG. 8B).

Since the insulating layer 3a is formed on the surface of the substrate 1 by a typical film formation method, the upper face 3e of the insulating layer 3a is parallel (substantially parallel) to the surface of the substrate 1. In other words, the upper face 3e of the insulating layer 3a is sometimes completely parallel to the surface of the substrate 1, but the upper face 3e is normally considered to be slightly inclined depending on the film formation environment and conditions. They can be said to be parallel with each other including such a slightly inclined case.

Regarding Step 3

In the step 3, an etching solution (etchant) is selected so that the amount of the insulating layer 3a etched with the etching solution is sufficiently smaller than the amount of the insulating layer 40 etched with the etching solution.

In the above-described second etching treatment, for example, when the insulating layer 40 is composed of silicon oxide and the first insulating layer 3a (insulating layer 30) is composed of silicon nitride, so-called buffered hydrofluoric acid (BHF) may be used as the etching solution. Buffered hydrofluoric acid (BHF) is a mixed solution of ammonium fluoride and hydrofluoric acid. When the insulating layer 40 is composed of silicon nitride and the first insulating layer 3a (insulating layer 30) is composed of silicon oxide, a hot phosphoric acid etching solution may be used as the etchant.

Through the step 3, the second insulating layer 3b having the same or substantially the same pattern as that shown in FIGS. 1A to 1C is formed. However, this does not mean that the second insulating layer 3b is not etched at all in the etching treatments performed after the step 3.

The depth (the distance in the depth direction) of the depression 7 is deeply related to the leakage current of the electron-emitting device. A value of the leakage current is decreased as the depth of the depression 7 is increased. However, the depression 7 with an excessive depth poses a problem in that the gate 5 is deformed or the like. Thus, the depth of the depression 7 is practically set to 30 nm or more and 200 nm or less. The depth of the depression 7 can also be rephrased as the distance from the side face 3f (or the corner 32) of the insulating layer 3a to the side face 3d of the insulating layer 3b.

The upper face 3e and the side face 3f of the insulating member 3 are not necessarily connected to each other so as to form a right angle, and can be connected to each other so as to form an obtuse angle. As shown in FIG. 3, the corner 32 that is a connecting portion (the boundary portion between the upper face and the side face) that connects the upper face to the side face of the insulating member 3 may have a certain curvature. In the case where the insulating member 3 includes the first insulating layer 3a and the second insulating layer 3b, the side face of the first insulating layer 3a corresponds to the side face of the insulating member 3.

Regarding Step 4

The conductive films (60A and 60B) are formed of a material constituting the cathode 6 by sputtering.

Any material can be used as the material (that is, the material constituting the cathode 6) of the conductive films (60A and 60B) as long as the material has conductivity and causes the field emission of electrons. The material preferably has a high melting point of 2000° C. or higher. The conductive material is preferably a material that has a work function of 5 eV or lower and whose oxide is easily etched. Suitable examples of the conductive material include metals such as Hf, V, Nb, Ta, Mo, W, Au, Pt, and Pd and alloys thereof. In consideration of the etching treatment performed in the step 5, the conductive material is particularly preferably Mo or W.

The film formation of the conductive films (60A and 60B) by sputtering is performed at a total pressure of 1.0 Pa or more and 2.8 Pa or less.

By performing such film formation, a conductive film including a region with high film density (grain portion) and a region with low film density (grain boundary portion) can be formed in a controlled manner. The density and composition of the conductive films (60A and 60B) are normally measured by XRR, XPS, or the like, but it is sometimes difficult to measure the density and composition of the actual electron-emitting device. In such a case, for example, the following method can be employed as the measurement method of density and composition. The quantitative analysis of elements is performed using a high-resolution electron energy loss electron microscope in which a TEM (transmission electron microscope) is combined with EELS (electron energy loss spectroscopy), to calculate density and composition.

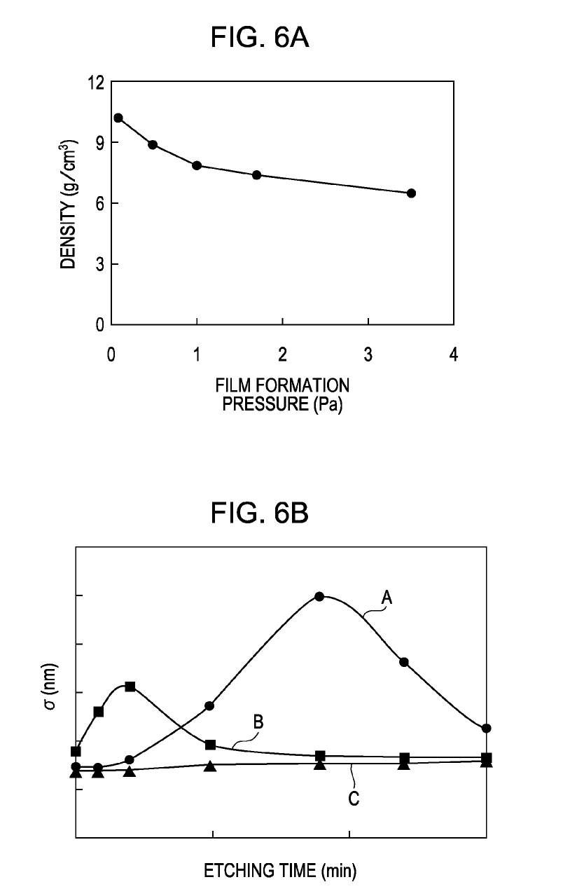

When the conductive films (60A and 60B) were formed at various total pressures during sputtering, it was found that, as shown in FIG. 6A, the rate of decline in film density is significantly decreased at a pressure of 1.0 Pa or more. The film density of the conductive films formed in the above-described pressure range becomes low (the number of grain boundary portions is increased) compared with the case where the conductive films are formed at a pressure lower than the above-described pressure range. Therefore, when the third etching treatment of the step 5 is performed on the conductive films (60A and 60B) formed in the above-described pressure range, effective protrusions 16 can be easily formed in a controlled manner in the step 5. FIG. 6A shows the relationship between the total pressure during film formation and the film density of a formed conductive film. With the above-described material that is suitable for the conductive films (60A and 60B), the relationship has a similar tendency. If the power during sputtering and the distance between the substrate 1 and a sputtering target are within a normal range, no particular dependence can be seen.

Argon (Ar) gas, krypton (Kr) gas, xenon (Xe) gas, or the like can be used as gas for sputtering, and argon gas is particularly desired in terms of manufacturing cost. A DC power supply or an RF power supply with an industrial power frequency of 13.56 MHz or the like can be used as a power supply for sputtering. The power during sputtering is a value obtained by dividing discharge power by the area of the target. The value is normally set to, for example, 1 W/cm² or more and 5 W/cm² or less. The distance between the sputtering target and the substrate 1 is normally set to, for example, 50 mm or more and 200 mm or less.

In some cases, a second conductive film is formed between the step 3 and the step 4 at a pressure lower than the above-described pressure range, so as to extend from the side face 3f to the upper face 3e of the first insulating layer 3a. In the electron-emitting device produced by forming a second conductive film with high film density below the conductive film 60A that later becomes the cathode 6, the wiring line and the cathode electrode 2 that drive the electron-emitting device can be connected to each of the protrusions 16 (electron emission portions) at a low resistance. Thus, a situation in which a desired electron emission current Ie is not obtained because of the voltage drop caused when the electron-emitting device is driven can be avoided. Furthermore, the adhesiveness of the conductive film 60A to the insulating member 3 can be improved.

Alternatively, in some cases, a second conductive film is formed on the surface (at least the plurality of protrusions 16) of the cathode 6, which has been formed in the step 5, at a pressure lower than the above-described pressure range. By covering the surface of the cathode 6 with the second conductive film having high film density, the resistance of the cathode 6 to processing and the stability during the operation can be improved. In addition, even if the resistance of the cathode 6 is increased through the step 5, the occurrence of a voltage drop described above can be suppressed.

The conductive film 60A and the conductive film 60B may be composed of the same material or different materials. However, the conductive film 60A and the conductive film 60B are preferably composed of the same material and formed at the same time in terms of the ease of production and the controllability of etching. The above-described second conductive film and the conductive film 60A may be composed of the same material or different materials. However, the second conductive film and the conductive film 60A are preferably composed of the same material in terms of the ease of production.

In this step, the conductive film 60A and the conductive film 60B may be formed so as to be in contact with each other or so as not to be in contact with each other. When the conductive film 60A and the conductive film 60B are formed so as to be in contact with each other, the gap 8 can be formed through the step 5. Therefore, the conductive film 60A and the conductive film 60B are desirably formed so as to be in contact with each other because the controllability of the gap 8 is improved.

When the electron-emitting device shown in FIGS. 1A to 1C is produced, a directional sputtering method is preferably employed because the conductive film 60A needs to be deposited on the corner 32 of the first insulating layer 3a shown in FIG. 8C.

In the directional sputtering method, for example, the angle between the substrate 1 and the sputtering target is set and a shielding plate is disposed between the substrate 1 and the sputtering target. A so-called collimation sputtering method, which uses a collimator that gives directivity to sputtered particles, is also in the category of directional sputtering methods. In such a manner, only sputtered particles (sputtered atoms) with restricted angles are incident upon the surface on which a film is to be formed. In particular, the incident angle of the sputtered particles (film formation material) relative to the oblique face 3f of the first insulating layer 3a is preferably smaller than the incident angle of the sputtered particles (film formation material) relative to the upper face 3e (corner 32) of the first insulating layer 3a. Herein, the incident angle of the sputtered particles relative to the upper face 3e of the first insulating layer 3a is set to be closer to 90 degrees than the incident angle of the sputtered particles relative to the oblique face 3f of the first insulating layer 3a is. In this case, the sputtered particles can be incident upon the upper face 3e of the first insulating layer 3a at an angle closer to vertical compared with the case where the sputtered particles are incident upon the oblique face 3f of the first insulating layer 3a. By performing such film formation, the protrusions 16 can be formed on the corner 32 of the first insulating layer 3a with high controllability.

Regarding Step 5

The third etching treatment may be performed by either dry etching or wet etching, but wet etching is preferably selected to easily set the etching selection ratio with respect to other materials.

The combination of the material of the conductive films (60A and 60B) with the etchant used in the third etching treatment is not particularly limited. However, for example, if the material of the conductive films (60A and 60B) is molybdenum (Mo), an alkali solution such as TMAH (tetramethylammonium hydroxide) or ammonia water is preferably used as the etchant. Alternatively, a mixture of 2-(2-n-butoxyethoxy)ethanol and alkanolamine, DMSO (dimethyl sulfoxide), or the like can also be used as the etchant. If the material of the conductive films (60A and 60B) is tungsten (W), a solution of nitric acid, hydrofluoric acid, sodium hydroxide, or the like is preferably used as the etchant.

Since the number of atoms removed per unit time in the etching treatment is uniquely determined in accordance with the material of the conductive films (60A and 60B) and the etching solution, the film density and the etching rate are inversely proportional to each other. The etching rate means the rate of change in thickness per unit time.

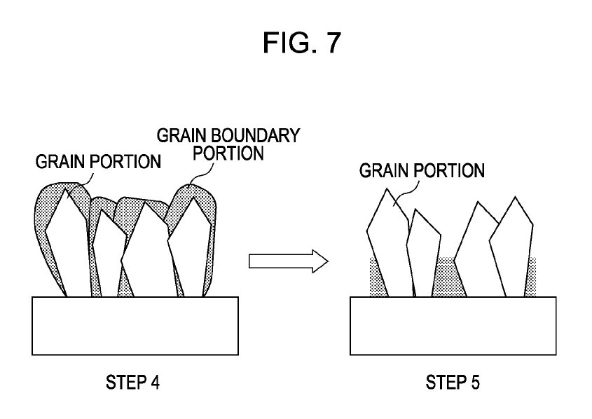

As described above, the conductive films (60A and 60B) formed in the pressure range described in the step 4 are conductive films each including grain portions that are suitable for forming effective protrusions 16 and grain boundary portions. There is a difference in etching selection ratio between the grain portions and the grain boundary portions. Therefore, when the etching treatment of the step 5 is performed on the conductive films (60A and 60B) formed in the above-described pressure range, it is believed that the grain boundary portions are preferentially etched rather than the grain portions, whereby the cathode 6 having effective protrusions 16 that are mainly composed of the grain portions can be formed. FIG. 7 shows the image of this process. In the step 5, not all the grain boundary portions are designed to be removed.

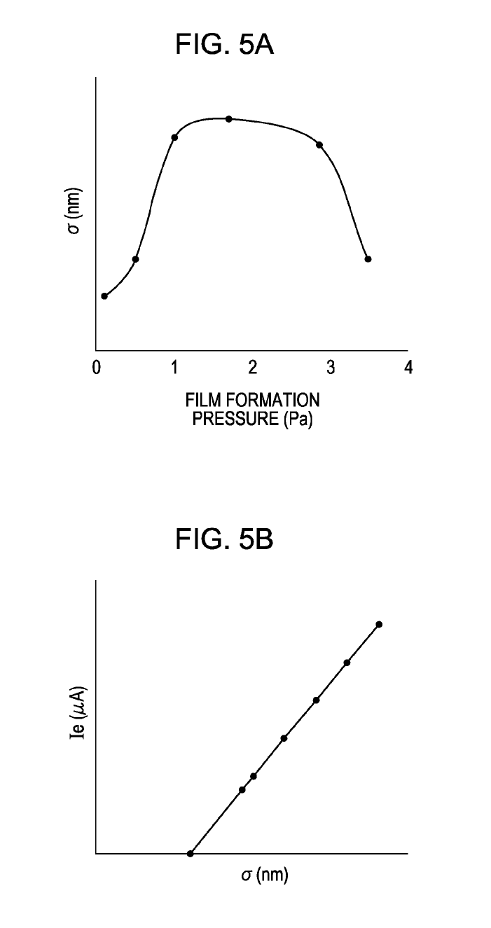

FIG. 5B is a schematic view showing the relationship between the standard deviation σ of the distance d from the cathode 6 to the gate 5 and the electron emission current Ie. As shown in FIG. 5B, there is a phenomenon in which the electron emission current Ie is increased as the standard deviation σ is increased. As is clear from the phenomenon, in the electron-emitting device, high electron emission current Ie can be achieved by forming protrusions 16 having a high value of σ.

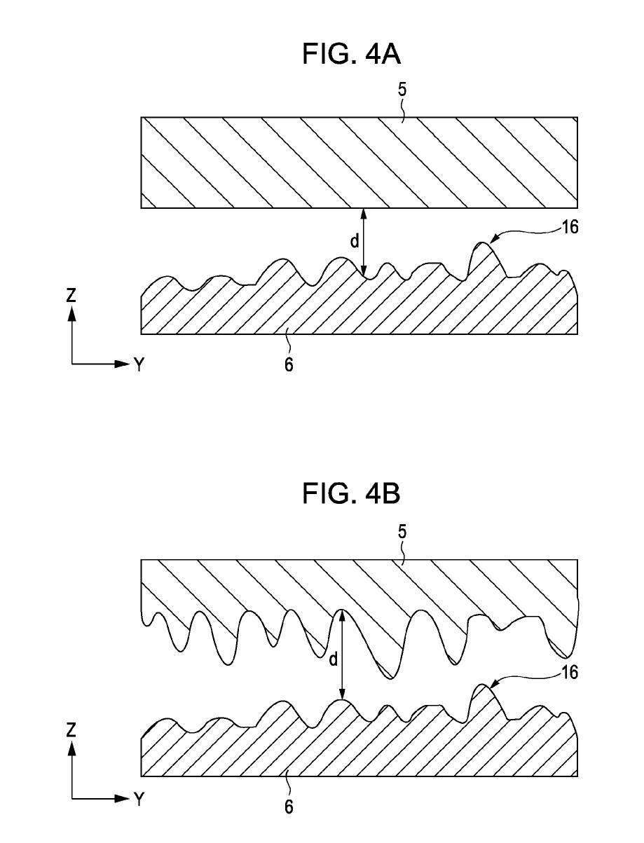

For example, the standard deviation σ of the distance d can be obtained by measuring the distances d between the cathode and the gate 5 in the gap 8 in the direction in which the gap 8 extends (the direction in which the corner 32 of the insulating member 3 extends). Specifically, the distance d is measured by observing the gap 8 using a SEM in the direction indicated by an arrow of FIG. 1B. FIGS. 4A and 4B each schematically show part of the gap 8 when the gap 8 is observed using a SEM in the direction indicated by an arrow of FIG. 1B. FIG. 4A is a schematic view when the gate does not include the conductive film 6B. FIG. 4B is a schematic view when the gate 5 includes the conductive film 6B. The distances d of the gap 8 are sequentially measured in the direction (Y direction) in which the gap 8 extends, and the standard deviation σ can be obtained from the measured values.

The distance d (the shape of the protrusions 16) between the cathode 6 and the gate 5 is dependent on the etching time. FIG. 6B is a graph showing the change in the distance d between the cathode 6 and the gate 5 as a function of the etching time at various total pressures during sputtering. The horizontal axis shows etching time and the vertical axis shows the standard deviation σ of the distance d between the cathode 6 and the gate 5 in the gap 8. In FIG. 6B, a curved line represented by A shows the case where the total pressure is 1.7 Pa. When the total pressure is in the range of 1.0 Pa or more and 2.8 Pa or less, similar curved lines are obtained. A curved line represented by B shows the case where the total pressure is 3.0 Pa. When the total pressure is more than 2.8 Pa, similar curved lines are obtained. A curved line represented by C shows the case where the total pressure is 0.1 Pa. When the total pressure is less than 0.1 Pa, similar curved lines are obtained.

The characteristics shown in FIG. 6B exhibit the same tendency among the materials that are suitable for the conductive films (60A and 60B). In particular when the material is Mo or W, the characteristics are produced with high reproducibility. Furthermore, the characteristics shown in FIG. 6B do not have particular dependence as long as the power during sputtering, the distance between the substrate 1 and the sputtering target, or the like is in the above-described normal range.

As shown in FIG. 6B, when the film formation is performed at a total pressure of 1.0 Pa or more and 2.8 Pa or less, high standard deviation σ can be obtained compared with the case where the film formation is performed at a pressure outside the above-described pressure range.

When the film formation is performed at a pressure higher than the above-described pressure range, the change in σ becomes more sensitive with respect to etching time. Thus, the controllability is significantly degraded compared with the case where the film formation is performed in the above-described pressure range. This may be because many grain boundary portions are formed compared with the case where the film formation is performed in the above-described pressure range, whereby it becomes difficult to form the protrusions 16 by the etching of the step 5 with high stability and controllability. Moreover, the maximum value of σ obtained becomes small compared with the case where the film formation is performed in the above-described pressure range.

When the film formation is performed at a pressure lower than the above-described pressure range, the standard deviation σ hardly changes even if the etching time in the step 5 is increased. In other words, the formation of the protrusions 16 in the step 5 is substantially not performed. This may be because many grain portions are formed compared with the case where the film formation is performed in the above-described pressure range, whereby effective etching for forming the protrusions 16 is not performed in the step 5.

FIG. 5A is a plot of the maximum values of σ obtained by etching of the step 5 when the total pressure during sputtering is changed. As is apparent from the graph, high standard deviation σ can be stably obtained at a total pressure of 1.0 Pa or more and 2.8 Pa or less.

As described above, by performing the etching described in the step 5 on the conductive films (60A and 60B) formed in the pressure range described in the step 4, the protrusions 16 having a high value of σ can be formed with high stability and controllability.

Regarding Step 6

The cathode electrode 2 has conductivity as with the gate 5, and can be formed by vapor deposition, a typical vacuum film formation method such as sputtering, or photolithography. The cathode electrode 2 and the gate 5 may be composed of the same material or different materials. The thickness of the cathode electrode 2 is set to several tens of nanometers to several micrometers and more preferably several hundreds nanometers to several micrometers.

Next, the peripheral structure of the protrusions 16 of the electron-emitting device produced by the above-described production method will now be described.

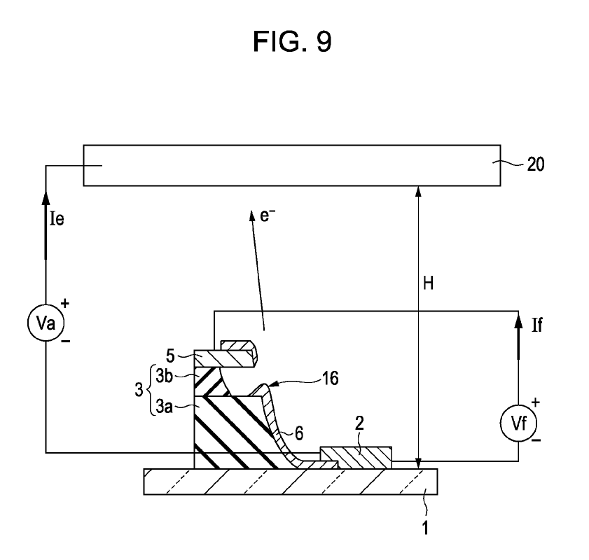

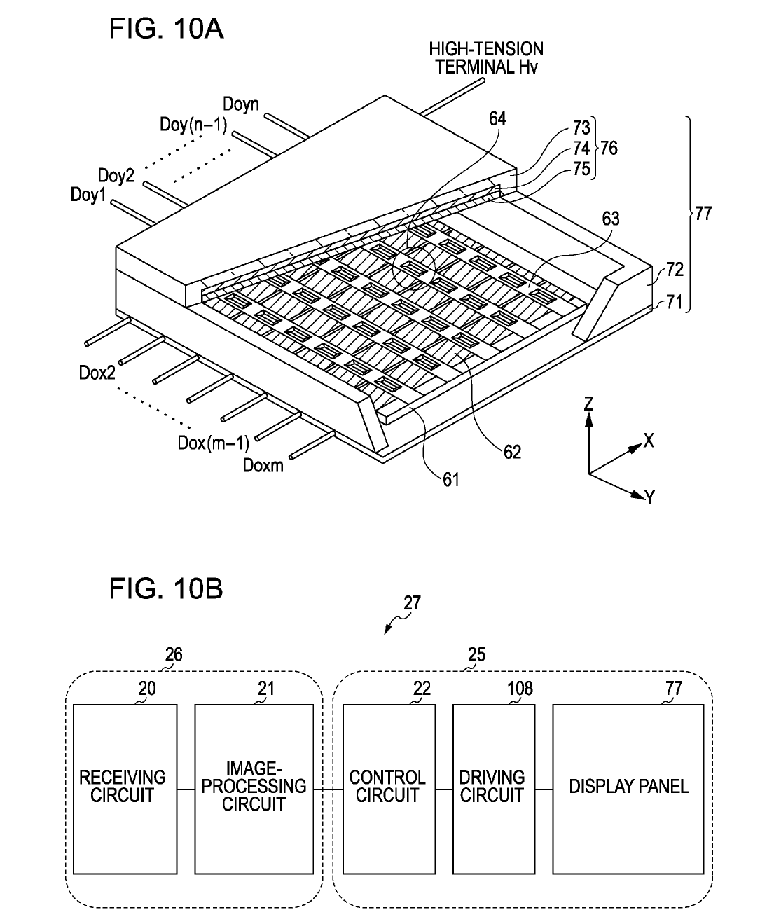

The cathode 6 includes the plurality of protrusions 16 arranged along the corner 32 (refer to FIG. 3), which is a boundary portion between the upper face 3e of the insulating member 3 and the side face 3f of the insulating member 3 (refer to FIG. 1C). The protrusions 16 have a projecting shape in a Z-X plane as shown in FIG. 1B and also have a projecting shape in a Z-Y plane as shown in FIG. 1C. The plurality of protrusions 16 each project from the corner 32 of the insulating member 3 so as to be apart from the upper face of the insulating member 3. In the electron beam-emitting device described below with reference to FIG. 9 or the display panel described below with reference to FIG. 10A, the plurality of protrusions 16 each project from the corner 32 of the insulating member 3 toward an anode described below. In other words, the plurality of protrusions 16 each project in a direction in which the insulating member 3 is stacked on the substrate 1 or a direction perpendicular to the surface of the substrate 1.

In the case where the cathode 6 includes the protrusions 16, the distance between the periphery of the protrusions 16 and the gate 5 is larger than the distance between the protrusions 16 and the gate 5. As a result, electrons emitted from the protrusions 16 are scattered at the gate 5 in an isotropic manner, and the electrons scattered to both sides of each of the protrusions 16 can reach the anode through the regions where the distance to the gate 5 is large. Thus, the electron emission efficiency η can be improved compared with the case where a flat cathode 6 is formed along the corner 32, that is, compared with the case where the distance between the gate and the cathode is constant along the corner 32.

As shown in FIGS. 1B and 3, the end of the cathode 6 on the gate 5 side covers at least part of the upper face (3e) of the insulating member 3 on the side face (3f) side. The plurality of protrusions 16 constituting the end of the cathode 6 are arranged along the corner 32 (refer to FIG. 1C), which is a boundary portion between the upper face (3e) of the insulating member 3 and the side face (3f) of the insulating member 3. Therefore, it can be said that the plurality of protrusions 16 of the cathode 6 each cover part of the upper face (3e) of the insulating member 3 on the side face (3f) side. Alternatively, it can also be said that part of the protrusions 16 of the cathode 6 enters the depression 7 of the insulating member 3, and the part of the protrusions 16 is connected to the upper face of the insulating member 3.

When the protrusions 16 are enlarged as shown in FIG. 3, the edge of each of the protrusions 16 has a shape determined by a curvature radius r. The electric field strength of the edge changes depending on the curvature radius r. Since the electric lines of force are increasingly concentrated as r is decreased, a high electric field can be formed on the edge of each of the protrusions 16. The distance d between the gate 5 and the cathode 6 affects the number of times of scattering of electrons at the gate. Thus, the electron emission efficiency (η) can be increased by decreasing r and increasing d. If the distance d is larger than 10 nm, the driving voltage Vf required for emitting electrons is excessively increased. Furthermore, the distance d is preferably 1 nm or more in consideration of the stability during the operation. If the distance d is smaller than 1 nm, the protrusions 16 of the cathode may be broken during the operation due to field evaporation, discharge, short circuits, or the like. Thus, the distance d is preferably 1 nm or more and 10 nm or less.

The protrusions 16 cover part of the upper face 3e of the insulating member 3, whereby the four advantages below are considered. The first advantage is that, since the protrusions 16 serving as electron emission portions are in contact with the insulating member 3 in a large area, mechanical adhesion is increased (adhesive strength is increased). The second advantage is that the thermal contact area between the protrusions 16 serving as electron emission portions and the insulating member 3 is increased, and thus the heat generated in the electron emission portions can be efficiently released to the insulating member 3 (thermal resistance is reduced). The third advantage is that, since the protrusions 16 are in contact with the upper face of the insulating member 3 with a gentle slope, the electric field strength at a triple junction that is generated at a boundary between an insulator, a vacuum, and a metal is decreased, whereby the occurrence of a discharge phenomenon caused by the generation of an abnormal electric field can be suppressed. The fourth advantage is that the electron emission efficiency is increased by providing a shape in which the surface of each of the protrusions 16 on the second insulating layer 3b side is inclined with respect to the normal to the rear face 5b of the gate 5.

Herein, the advantage achieved from the structure in which the protrusions 16 cover not only the side face 3f of the insulating member 3 but also part of the upper face 3e of the insulating member 3 will be further described in detail.

Initial Ie and the time variation in Ie were measured at various lengths x of the end (protrusion 16) of the cathode 6 on the gate 5 side, the end entering the depression 7 from the side face 3f of the insulating member 3. The amount of decrease in Ie from the initial Ie tended to become larger as the length x was decreased. Herein, the length x corresponds to x in FIG. 3, and can be regarded as the length of the protrusions 16 that are connected to the upper face of the insulating member 3. Furthermore, Ie means the amount of emission current and corresponds to the amount of electrons that reach an anode 20 shown in FIG. 9 described below.

The amount of decrease in Ie from the initial Ie became larger as the length x was decreased. However, when x was more than 20 nm, the dependence of Ie on x tended to be reduced.

It is believed from the results that, since the protrusions 16 are brought into contact with the insulating member 3 in a large area by increasing x, thermal resistance is reduced. Furthermore, this may be because the heat capacity is increased due to an increase in the volume of protrusions 16 and the temperature of the edge of each of the protrusions 16 is decreased, whereby the initial variation is decreased.

It is not necessarily preferable that the length x be larger. Practically, the length x is set to 10 nm or more and 30 nm or less. The length x can be controlled by controlling the angle of the material of the cathode 6 during vapor deposition, the thickness of the second insulating layer 3b, and the thickness of the gate 5. If x is more than 30 nm, leakage is generated between the cathode 6 and the gate 5 through the upper face of the insulating member 3, and thus leakage current is increased.

The edge of each of the protrusions 16 of the cathode 6 is desirably kept as far apart from the gate 5 as possible (the distance d is increased). In this case, the scattering of electrons is decreased at the gate 5, and thus the electron emission efficiency η and the amount of emission current Ie are improved.

As shown in FIG. 3, an offset Dx is desirably set between the edge of each of the protrusions 16 of the cathode 6 and the side face 5a of the gate 5. In other words, it is desired to dispose the gate 5 so that the side face 5a of the gate 5 is located closer to the second insulating layer 3b than the protrusions (particularly the edge) of the cathode 6 are. This is desired in order to improve the electron emission efficiency η (increase the amount of emission current Ie) and stabilize electron emission. The gate 5 is not located right above the edge of each of the protrusions 16, which reduces the possibility that electrons subjected to field emission from the edge of each of the protrusions 16 collide with the rear face 5b of the gate 5. Consequently, the electron emission efficiency η (the amount of emission current Ie) is improved while at the same time reactive current (device current If) that flows in the gate 5 is reduced. Thus, the thermal deformation of the gate is suppressed and stable electron emission can be achieved.

Next, description of a triple junction will be made. A site where three types of materials such as a vacuum, an insulator, and a metal having different dielectric constants are connected to one another is normally called a triple junction. In some cases, the electric field strength at a triple junction becomes excessively higher than that at the periphery of the triple junction and thus discharge or the like is caused. Therefore, when the angle θ (refer to FIG. 3) between the protrusions 16 and the upper face of the insulating member 3 is larger than 90 degrees, there is not much difference between the electric field strength at a triple junction and the electric field strength at the periphery of the triple junction. However, for example, in the case where the cathode 6 is detached from the upper face of the insulating member 3 due to a lack of mechanical strength for some reason and a gap is formed between the upper face of the insulating member 3 and the cathode 6, the angle θ falls below 90 degrees. Consequently, a high electric field is formed in the portion from which the cathode 6 is detached and electron emission may be caused from the portion. Furthermore, the electron-emitting device may be broken due to creeping discharge caused by the electron emission. The angle θ between the protrusions 16 of the cathode 6 and the upper face of the insulating member 3 is desirably larger than 90 degrees.

Next, modifications of an electron-emitting device that is produced by applying the production method of this embodiment will now be described.

To stabilize electron emission characteristics and particularly to stabilize emission current, it is desired that the plurality of protrusions 16 of the cathode 6 do not interfere with each other as much as possible.

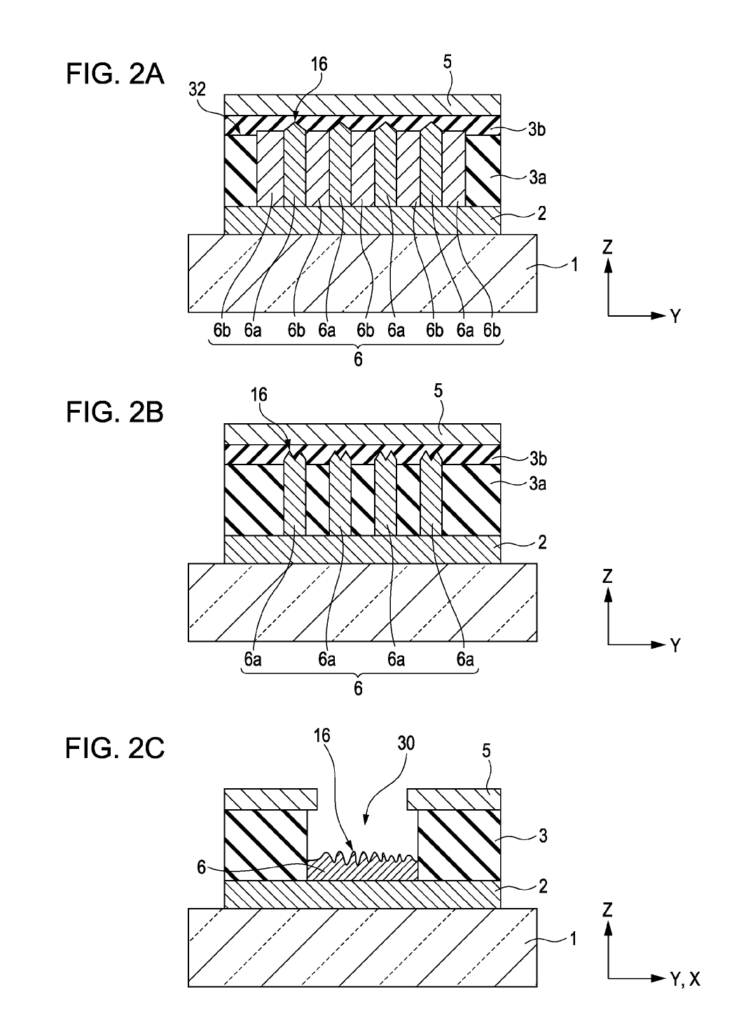

The following configuration is desired. As shown in FIG. 2A, portions (6b) that are parts of the cathode 6 and are each located between the plurality of protrusions 16 are formed in the direction in which electrons flow from the cathode electrode 2 to the protrusions 16, so as to have a resistance higher than that of the other portions (6a). Specifically, it is desired that the resistance between two adjacent protrusions 16 is higher than the resistance between each of the protrusions 16 and the cathode electrode. In this case, the mutual influence of the plurality of protrusions 16 of the cathode 6 can be reduced. The resistance of the portions denoted by 6b can be increased by, for example, selectively oxidizing only the portions denoted by 6b and exposed while the portions denoted by 6a of the cathode 6 are masked. The method for increasing resistance is not limited to oxidation, and the resistance can be increased by other well-known methods such as doping.

In addition to the configuration described above, the following configuration is desired. A resistor element is disposed in all or part of each of the portions (the portions that connect the cathode electrode 2 and the protrusions 16) denoted by 6a in FIG. 2A. In this case, each of the electron emission portions (protrusions 16) individually has resistance, and thus the time variation in emission current from each of the electron emission portions can be suppressed. In this configuration, the resistance between two adjacent protrusions 16 is also higher than the resistance between each of the protrusions 16 and the cathode electrode.

When the side face 3f of the insulating member 3 is flat, it is desired that the portions denoted by 6a have a thickness larger than that of the portions denoted by 6b. In this case, the creepage distance between the plurality of protrusions 16 serving as electron emission portions can be increased compared with the case where the thickness of the portions denoted by 6a is equal to that of the portions denoted by 6b. At the same time, the portions denoted by 6b have a resistance higher than that of the portions denoted by 6a, and therefore the mutual influence of the plurality of protrusions 16 can be reduced as described above. Moreover, the configuration shown in FIG. 2B can be employed by removing the portions denoted by 6b. In this configuration, since the portions denoted by 6b are not present, the mutual influence of the plurality of protrusions 16 can be further reduced. It has been described in FIG. 2A that the number of protrusions 16 included in each of the portions denoted by 6a is one, but each of the portions denoted by 6a can include a plurality of protrusions 16 as shown in FIG. 2B. However, to reduce the mutual interference (influence) of the plurality of protrusions 16, the number of protrusions 16 included in each of the portions denoted by 6a is desirably one.

In the configuration shown in FIG. 2A, the cathode 6 includes the portions that are denoted by 6a and are essential for connecting each of the protrusions 16 to the cathode electrode 2, and the portions denoted by 6b. The portions denoted by 6b can prevent the regions that are parts of the side face 3f of the insulating member 3 and are located between the plurality of protrusions 16, from being charged through the exposure to a vacuum. As shown in FIG. 2B, when the cathode 6 does not include the portions denoted by 6b, some of the electrons emitted from the protrusions 16 and scattered at the gate 5 in an isotropic manner electrify the regions that are parts of the side face 3f of the insulating member 3 and are located between the plurality of protrusions 16. As a result, it is considered that the electron emission becomes unstable and the paths of electrons emitted are varied over time. Therefore, as shown in FIG. 2A, the cathode 6 desirably includes the portions (6b) located between the plurality of protrusions 16, in addition to the portions (6a) that are essential for connecting each of the protrusions 16 to the cathode electrode 2. Furthermore, as shown in FIGS. 1C and 2A, the cathode 6 desirably covers the portions that are parts of the corner 32 of the insulating member 3 and are each located between two adjacent protrusions 16. By disposing part of the cathode 6 between the plurality of protrusions 16 in such a manner, the surface of the insulating member 3, the surface being located between the plurality of protrusions 16, can be prevented from being charged and the electron emission can be stabilized.

The emission current can be stabilized by simply increasing the resistance of the conductive film 6 including the protrusions 16, instead of increasing the resistance of only the portions denoted by 6b in FIG. 2A. To achieve this, for example, a step of increasing the resistance of the cathode 6 may be performed after the step 5. For instance, the resistance can be increased by lightly oxidizing the cathode 6. The method for increasing resistance is not limited to the oxidation, and resistance can be increased by other known methods such as doping.

In the example above, the configuration in which the cathode 6 is formed on the side face of the insulating member 3 has been described as an electron-emitting device. However, the configuration of the electron-emitting device to which the production method of this embodiment is applied is not limited to such a configuration. For example, the following configuration shown in FIG. 2C may be employed. As shown in FIG. 2C, the cathode electrode 2 is formed on the surface of the substrate 1, and the cathode 6 is formed on a portion of the cathode electrode 2, the portion being located right below an opening 30 of the gate 5. The gate 5 has a circular opening 30 and the gate 5 and the substrate 1 sandwich the insulating member 3. In FIG. 2C, the cathode electrode 2 is formed between the insulating member 3 and the substrate 1, but is not necessarily formed therebetween as long as electrons can be supplied to the cathode 6. In the case where the above-described production method is applied to the electron-emitting device having such a configuration, the cathode electrode 2, the insulating member 3, and the gate 5 are stacked on the substrate 1; the opening 30 is formed in the gate and an opening that communicates with the opening 30 is formed in the insulating member 3; and the above-described steps 4 and 5 are performed. Consequently, the electron-emitting device having the configuration shown in FIG. 2C can be formed. In this configuration, the cathode electrode 2 corresponds to a base on which a conductive film composed of a material constituting the cathode 6 is deposited. Alternatively, the substrate 1 and the cathode electrode 2 correspond to a base on which a conductive film composed of a material constituting the cathode 6 is deposited.

Next, a measurement method of electron emission characteristics of the electron-emitting device produced by the production method of this embodiment and the efficiency at which electrons emitted from the cathode 6 reach the anode, that is, the electron emission efficiency (η) will now be described. The electron emission efficiency η is given as η=Ie/(If+Ie), where If is a current detected when a voltage is applied to the electron-emitting device and Ie is a current extracted into a vacuum when a voltage is applied to the electron-emitting device (current that reaches the anode). The electron emission characteristics can be measured using the configuration shown in FIG. 9. In FIG. 9, Vf is a voltage applied between the gate 5 and the cathode 6 and If is a device current that flows between the gate 5 and the cathode 6 when the Vf is applied between the gate 5 and the cathode 6. Furthermore, Va is a voltage applied between the cathode 6 and the anode 20 and Ie is an electron emission current. Herein, an example in which the Va is applied between the cathode 6 and the anode 20 has been described, but a power supply that applies a potential to the anode 20 and a power supply that applies a potential to the cathode 6 may be separately disposed. As shown in FIG. 9, by disposing the anode 20 above the substrate 1 on which the electron-emitting device is formed, the anode 20 being provided with a higher potential than the gate 5 and the cathode 6, there is obtained an electron beam-emitting device in which electrons emitted from the plurality of protrusions 16 reach the anode 20.

An electron source obtained by arranging, on a substrate, a plurality of the electron-emitting devices produced by the production method of this embodiment and a display panel that uses the electron source will now be described with reference to FIGS. 10A and 10B.

FIG. 10A is a schematic view showing an example of a display panel 77 that uses an electron source obtained by arranging electron-emitting devices in a matrix. A portion of the display panel 77 is cut away so that the inside can be seen. In FIG. 10A, 61 denotes an electron source substrate, 62 denotes an X-direction wiring line, and 63 denotes a Y-direction wiring line. The electron source substrate 61 corresponds to the substrate 1 of the electron-emitting device described above. Furthermore, 64 schematically denotes the electron-emitting device. The X-direction wiring line 62 is a common wiring line that connects the cathode electrodes 2 to one another and the Y-direction wiring line 63 is a common wiring line that connects the gates 5 to one another. Herein, an example in which the electron-emitting device is disposed at the intersecting portion of the X-direction wiring line 62 and the Y-direction wiring line 63 has been schematically described. However, the electron-emitting device can be disposed on the electron source substrate beside the intersecting portion of the X-direction wiring line 62 and the Y-direction wiring line 63.

The X-direction wiring lines 62 are connected to scanning signal application means (not shown) configured to apply scanning signals for selecting a row of the electron-emitting devices 64 arranged in the X direction. The Y-direction wiring lines 63 are connected to modulating signal generation means (not shown) configured to modulate each column of the electron-emitting devices 64 arranged in the Y direction in response to input signals. A driving voltage applied to each electron-emitting device is fed as the differential voltage between the scanning signals and the modulating signals applied to each electron-emitting device.

In the above-described configuration, each device can be made independently operational by selecting each device with simple matrix wiring.

In FIG. 10A, the electron source substrate 61 is fixed on a rear plate 71. A face plate 76 includes a light-emitting member 74 composed of, for example, a fluorescent member that emits light through the irradiation with electrons emitted from the electron-emitting devices and a metal back 75 that corresponds to the above-described anode 20, both of which are stacked on an inner surface of a glass substrate 73. A display panel 77 includes the rear plate 71 and the face plate 76 hermetically sealed with each other with a supporting frame 72 and a connecting member such as frit glass therebetween. As described above, the display panel 77 includes the face plate 76, the supporting frame 72, and the rear plate 71. The rear plate 71 is provided mainly for the purpose of enhancing the strength of the electron source substrate 61. For this reason, when the electron source substrate 61 itself has sufficiently high strength, the rear plate 71 is not necessarily provided. Alternatively, the display panel 77 having sufficiently high strength against the atmospheric pressure can be formed by providing a support member called a spacer (not shown) between the face plate 76 and the rear plate 71.

Next, a display 25 including the above-described display panel 77 and a television apparatus 27 will now be described with reference to a block diagram of FIG. 10B.

A receiving circuit 20 receives television signals of satellite broadcasting, terrestrial broadcasting, or the like and various signals of data broadcasting or the like using a network and outputs the decoded video data to an image-processing unit 21. Herein, the above-described “received signal” can be rephrased as an “input signal”. The image-processing unit 21 includes a γ correction circuit, a resolution conversion circuit, and an I/F circuit. The image-processing unit 21 converts the video data subjected to image processing into a display format of the display (image display apparatus) 25 and outputs the video data to the display (image display apparatus) 25 as an image signal.

The display 25 includes at least the above-described display panel 77 and further includes a driving circuit 108 and a control circuit 22 configured to control the driving circuit 108. The control circuit 22 performs signal processing such as correction processing on input image signals and outputs the image signals and various control signals to the driving circuit 108. The control circuit 22 includes a sync-signal separation circuit, an RGB conversion circuit, a luminance signal conversion unit, and a timing control circuit. The driving circuit 108 outputs driving signals to the electron-emitting devices inside the display panel 77 in accordance with the input image signals, and thus a television image is displayed in accordance with the driving signals. The driving circuit 108 includes a scanning circuit, a modulation circuit, and a high-voltage power supply circuit configured to supply an anode potential. The receiving circuit 20 and the image-processing unit 21 may be accommodated in a housing different from the display 25, that is, in a set-top box (STB 26) or may be accommodated in a housing that is integral with the display 25. Herein, an example in which the television apparatus 27 displays a television image has been described. However, if the receiving circuit 20 is a circuit configured to receive an image distributed through a network such as the Internet, the television apparatus 27 functions as an image display apparatus that can display not only a television image but also various images.

### EXAMPLES

More specific examples based on the above-described embodiment will now be described.

### Example 1

A method for producing an electron-emitting device of this Example will be described with reference to FIGS. 8A to 8F.

First, as shown in FIG. 8A, insulating layers 30 and 40 and a conductive layer 50 were stacked on a substrate 1. The substrate 1 was composed of high-strain-point low-sodium glass (PD200 available from Asahi Glass Co., Ltd.).

The insulating layer 30 was obtained by forming a silicon nitride film by sputtering so as to have a thickness of 500 nm. The insulating layer 40 was obtained by forming a silicon oxide film by sputtering so as to have a thickness of 30 nm. The conductive layer 50 was obtained by forming a tantalum nitride film by sputtering so as to have a thickness of 30 nm.

As shown in FIG. 8B, after a resist pattern was formed on the conductive layer 50 by photolithography, the conductive layer 50, the insulating layer 40, and the insulating layer 30 were processed in sequence by dry etching. Through this first etching treatment, the conductive layer 50 and the insulating layer 30 were patterned into a gate 5 and a first insulating layer 3a, respectively. Herein, since a material that forms a fluoride was selected for the insulating layers (30 and 40) and the conductive layer 50, CF₄ gas was used as an etching gas. As a result of RIE with the gas, the angle between the side faces of the insulating layers (30 and 40) and the gate 5 and the surface (horizontal surface) of the substrate was about 60°.

After the resist was removed, as shown in FIG. 8C, the insulating layer 40 was etched with BHF (high-purity buffered hydrofluoric acid LAL100 available from STELLA CHEMIFA CORPORATION) so that the resultant depression 7 had a depth of about 70 nm. Herein, BHF is a mixture of 0.9 wt % of NH₄HF₂ and 16.4 wt % of NF₄F. Through this second etching treatment, the depression 7 was formed in an insulating member 3 composed of the first insulating layer 3a and a second insulating layer 3b.

As shown in FIG. 8D, molybdenum (Mo) was formed by directional sputtering on the oblique face 3f and the upper face 3e of the first insulating layer 3a and the gate 5 so that the thickness of molybdenum at least on the oblique face 3f of the first insulating layer 3a was 35 nm. The substrate 1 was set such that the surface of the substrate 1 was horizontal to a sputtering target. In this Example, a shielding plate was disposed between the substrate 1 and the target so that sputtered particles were incident upon the surface of the substrate 1 at restricted angles (specifically, 90±10° relative to the surface of the substrate 1). The sputtering was performed under the conditions below: the power of argon plasma was 1 W/cm², the distance between the substrate 1 and the target was 100 mm, and the total pressure was 1.7 Pa. A conductive film 60A was formed so as to enter the depression 7 by 35 nm (the length x in FIG. 3).

In such a manner, the conductive film 60A and a conductive film 60B were formed at the same time so as to be in contact with each other.

As shown in FIG. 8E, wet etching treatment (third etching treatment) was performed on the conductive film 60A and the conductive film 60B. As an etchant, 0.238 wt % of TMAH (tetramethylammonium hydroxide) was used. The conductive film 60A and the conductive film 60B were immersed in the etchant for 40 seconds and then cleaned with running water for 5 minutes. By performing alkali treatment on the conductive films (60A and 60B) in such a manner, grain boundary portions having low film density were preferentially etched. Consequently, many protrusions 16 were formed along the corner 32.

Finally, as shown in FIG. 8F, a cathode electrode 2 was formed by sputtering. The cathode electrode 2 was composed of copper (Cu) and had a thickness of 500 nm.

As shown in FIG. 9, an anode electrode 20 was disposed 1.7 mm above the electron-emitting device produced in this Example, and the electron emission characteristics were measured. When a driving voltage Vf applied between the cathode electrode 2 and the gate 5 was 23 V, electron emission current Ie was 6 μA.

### Comparative Example 1

In Comparative Example 1, an electron-emitting device was produced in the same manner as in Example 1, except that the total pressure during sputtering in Example 1 was changed to 0.1 Pa. The electron emission characteristics of the electron-emitting device were measured in the same manner as in Example 1. When a driving voltage applied between the cathode electrode 2 and the gate 5 was 23 V, the electron emission current Ie was 1 μA. The distance d of the gap 8 of the electron-emitting device in this Comparative Example was slightly smaller than that of the electron-emitting device in Example 1 on average. The standard deviation σ of the distance d in the electron-emitting device of this Comparative Example was obviously smaller than the standard deviation σ of the distance d in the electron-emitting device of Example 1. After the electron emission characteristics were confirmed, the electron-emitting device was observed with a SEM. Consequently, the distance d between the protrusions 16 and the gate 5 was almost constant along the corner 32, and a plurality of effective protrusions 16 arranged along the corner 32 (in a Y direction) as shown in FIG. 1C were not confirmed.

### Comparative Example 2

In Comparative Example 2, an electron-emitting device was produced in the same manner as in Example 1, except that the total pressure during sputtering in Example 1 was changed to 3.0 Pa. The electron emission characteristics of the electron-emitting device were measured in the same manner as in Example 1. When a driving voltage applied between the cathode electrode 2 and the gate 5 was 23 V, the electron emission current Ie was 1.5 μA. The distance d of the gap 8 of the electron-emitting device in this Comparative Example was larger than that of the electron-emitting device in Example 1 on average. The standard deviation σ of the distance d in the electron-emitting device of this Comparative Example was larger than the standard deviation σ of the distance d in the electron-emitting device of Comparative Example 1. However, the standard deviation σ in the electron-emitting device of this Comparative Example was smaller than the standard deviation σ in the electron-emitting device of Example 1.

### Example 2

In this Example, an electron-emitting device was produced basically in the same manner as in Example 1, except that a second conductive film was formed before the conductive films (60A and 60B) were formed. The second conductive film was also formed by sputtering Mo.

In this Example, the second conductive film was formed so as to have a thickness of 20 nm under the same sputtering conditions as in Example 1, except that the total pressure during the sputtering of the conductive films (60A and 60B) in Example 1 was changed to 0.1 Pa. The second conductive film was immersed in BHF (high-purity buffered hydrofluoric acid LAL100 available from STELLA CHEMIFA CORPORATION) for 30 seconds and then cleaned with running water for 5 minutes. After the second conductive film was formed in such a manner, the conductive films (60A and 60B) were formed under the same conditions as in Example 1 so as to each have a thickness of 20 nm. Subsequently, the electron-emitting device of this Example was produced by performing the same processes as in Example 1.

The electron emission characteristics of the electron-emitting device of this Example were measured in the same manner as in Example 1. A driving voltage Vf required to obtain the same emission current Ie was decreased.

### Example 3

In this Example, an electron-emitting device was produced basically in the same manner as in Example 1, except that a second conductive film was formed after the conductive films (60A and 60B) were formed. The second conductive film was also formed by sputtering Mo.

In this Example, the conductive films (60A and 60B) were formed under the same conditions as in Example 1 so as to each have a thickness of 20 nm, and then etched under the same conditions as in Example 1. Subsequently, a second conductive film was formed. In this Example, the second conductive film was formed under the same conditions as those of the second conductive film formed in Example 2 so as to have a thickness of 15 nm. However, in this Example, the etching treatment performed on the second conductive film in Example 2 was not performed. Subsequently, a cathode electrode 2 was formed in the same manner as in Example 1 to produce the electron-emitting device of this Example.

The electron emission characteristics of the electron-emitting device of this Example were measured in the same manner as in Example 1. The rate of decline in emission current Ie was decreased compared with the electron-emitting device of Example 1.

### Example 4

In this Example, an electron source was produced by arranging the electron-emitting devices of Example 1 in a matrix, and a display panel was manufactured using the electron source. Specifically, 1080 row wiring lines and 3×1920 column wiring lines were formed on a rear plate 71 composed of a glass substrate by screen printing with silver paste. Subsequently, an electron-emitting device was formed beside each of the intersecting portions of the row wiring lines and the column wiring lines by the same method as the production method of Example 1. Furthermore, 1080×3×1920 fluorescent members 74 (1080×1920 pixels) were formed on the surface of a glass substrate 73, and a metal back 75 made of aluminum was stacked thereon to form a face plate 76. Inside a vacuum chamber, a supporting frame 72 including frit glass provided in advance was disposed between the rear plate 71 and the face plate 76 to hermetically seal the rear plate 71 and the supporting frame with each other and also the face plate 76 and the supporting frame with each other using frit glass. Through the processes described above, an FED display (display panel 77) in which a vacuum is maintained was produced. The television apparatus 27 shown in FIG. 10B was produced using the display panel, and the television apparatus 27 could display a high-brightness image over a long time.

According to the present invention, an electron-emitting device that includes fine protrusions and has satisfactory electron emission characteristics can be formed by a simple method with high controllability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Application No. PCT/JP2009/067498, filed Oct. 7, 2009, which is hereby incorporated by reference herein in its entirety.

What is claimed is:

1. A method for producing an electron-emitting device including a cathode having a plurality of protrusions, the method at least comprising:
forming a conductive film composed of a material constituting the cathode on a base by sputtering at a total pressure of 1.0 Pa or more and 2.8 Pa or less; and
performing etching treatment on the conductive film to form a cathode having a plurality of protrusions on a surface thereof.

2. The method for producing an electron-emitting device according to claim 1, further comprising, before the forming of the conductive film, forming another conductive film, that is different from the aforementioned conductive film, between the aforementioned conductive film and the base by sputtering at a total pressure of less than 1.0 Pa.

3. The method for producing an electron-emitting device according to claim 1, further comprising, after the etching treatment, stacking another conductive film that is different from the conductive film on the cathode by sputtering at a total pressure of less than 1.0 Pa.

4. The method for producing an electron-emitting device according to claim 2, wherein the conductive film and said another conductive film are composed of the same material.

5. The method for producing an electron-emitting device according to claim 1, wherein the cathode is composed of molybdenum or tungsten.

6. The method for producing an electron-emitting device according to claim 1,
wherein the base is an insulating member including an upper face and a side face communicating with the upper face, and
the conductive film is formed so as to extend from the side face to the upper face of the insulating member and cover at least part of a boundary portion between the side face and the upper face.

7. A method for producing an image display apparatus including a plurality of electron-emitting devices and a light-emitting member irradiated with electrons emitted from the plurality of electron-emitting devices, wherein each of the electron-emitting devices is produced by the production method according to claim 1.
